(19) United States
(12) Patent Application Publication
(10) Pub. No.: US 2008/0248795 A1
(43) Pub. Date: Oct. 9, 2008

(54) Call results failure classifications

(75) Inventors: David Petersen, San Francisco, CA (US); Padraig Stapleton, Pleasanton, CA (US); Kevin Hannan, San Mateo, CA (US)

Correspondence Address: HANLEY, FLIGHT & ZIMMERMAN, LLC, 150 S. WACKER DRIVE, SUITE 2100, CHICAGO, IL, 60606, US

(73) Assignee: TELEPHIA INCORPORATION, SAN FRANCISCO, CA (US)

(21) Appl. No.: 11/784,883

(22) Filed: Apr. 9, 2007

(51) Int. Cl. H04Q 7/20

(52) U.S. Cl. 455/423

(57) ABSTRACT

A method of classifying a call failure. In one embodiment, an indication of a call failure is received and the cause of the failed call is automatically identified and classified. In one embodiment, identifying the cause of a call failure comprises determining signal characteristics, determining network resource availability, and determining cellular structure characteristics. In one embodiment, a call failure is classified as coverage failure if the signal strength is below an acceptable threshold or if a wireless device initiates a call and receives no response from the network or when the signal interference is above an acceptable threshold. In one embodiment, a call failure is classified as capacity failure if a network is unable to accommodate a wireless device with a communication channel or resources. A call failure is classified as operational failure if the call failure is related to mistakes in a configuration file defining and identifying cellular structures.

### TECHNICAL FIELD

The present invention relates to the field of wireless communication systems. More particularly, embodiments of the present invention relate to a method and system for automatically classifying call failures in a wireless network.

### BACKGROUND ART

Increase in use of wireless devices over the past few years has led to new challenges. For example, fewer network resources are available to wireless devices seeking access to a wireless network since network resources (e.g., communication channels) are limited while the number of wireless devices are increasing. Moreover, increasing number of wireless devices has increased expectation of higher performance and improvement in connectivity. Accordingly, dropped calls and failed calls are no longer acceptable.

To achieve higher performance and to improve connectivity, dropped calls and failed calls are monitored. As a result, the cause of a call failure may be identified and remedied. Dropped calls and failed calls may be related to a number of issues. For example, a wireless user may enter a building where wireless signal cannot penetrate, and as a result the call is dropped. In other instances, a wireless user may wonder off, to an area where signal strength is below a certain threshold, and as a result the call is failed.

Failed call may also occur during handover. For example, when a wireless user is traveling between different wireless cellular structures, the wireless connection must be handed over to the cellular structure that the wireless user is entering. However, when the cellular structure that the user has entered does not have the capacity to accommodate an additional wireless user, the call drops.

Call failures may be operational which may be associated with inadvertent mistakes in the configuration files stored in the base station controller, mobile switching center or other similar network wireless structures. Configuration files store and define the parameters of each cellular structure and identify the neighboring cellular structures. Accordingly, when a wireless device user seeks to connect to a wireless network, the configuration file of the cellular structure that the user presides in is used to setup parameters of the call. Moreover, when a wireless user travels from one cellular structure to its neighboring cellular structure, the configuration file that defines the neighboring cellular structure identifies the neighboring cellular structure. Therefore, the communication channel is handed over to the neighboring cellular structure. However, if the neighboring cellular structure is not properly defined or identified, when the user travels to that neighboring cellular structure, the call fails or drops.

Conventionally, to improve wireless networks, engineers manually analyze log files stored in a wireless device or log files stored by the network (e.g., base station controller, mobile switching center, etc.). Upon manually analyzing the log files, engineers manually classify call failures and call drops (e.g., coverage problem, capacity problem, or operational problems). Manual identification and manual classification of failed calls may then be used to remedy and address the cause of the call failure.

Unfortunately, manually analyzing log files and manually classifying call failures is not only tedious but it is prone to human error. Moreover, manually analyzing log files and manually classifying call failures is expensive and time consuming.

### SUMMARY

Accordingly, a need has arisen to automatically identify call failures and to automatically classify call failures such that the cause of call failures can be remedied. Moreover, a need has arisen to increase accuracy of the analysis and classification of call failures by making it less prone to human error. Additionally, a need has arisen to identify and classify call failures in a timely fashion. It will become apparent to those skilled in the art after reading the detailed description of the present invention that the embodiments of the present invention satisfy the above mentioned needs.

In one embodiment, a plurality of messages (e.g., layer three messages, radio frequency (RF) status, cause code and etc.) is received. The plurality of messages may be stored on a wireless device or may be stored by a wireless network or any combination thereof. The messages can automatically be used to identify a failed call and the cause of the failed call. Accordingly, the cause may be used to automatically classify the call failure. For example, when signal strength below an acceptable level is determined, the call failure may be classified as a coverage failure. In other instances, a call failure may also be classified as a coverage failure when a wireless device seeks to establish a connection but receives no response from a wireless network.

In one embodiment, a message for a failed call is automatically analyzed. The message is automatically classified as a capacity failure when the message indicates unavailability of communication channel in a wireless network. Similarly a failed call is automatically classified as a capacity failure when a message indicates unavailability of resources in a wireless network (e.g., lack of circuitry to process a request).

In one embodiment, a failed call is automatically classified as an operational failure by default when it is not classified as coverage or capacity failure. However, other embodiments may use a statistical analysis of a configuration file that defines and identifies a cellular structure with its neighboring cellular structures to classify a call failure as an operational failure. In one embodiment, processing configuration files and statistically comparing the configuration file of a cellular structure where the call failed with configuration files from other cellular structures may identify statistical differences between the cellular structures. When the statistical differences between two cellular structures are more than a given threshold, a failed call is automatically classified as an operation failure.

As a result of automating identifying and classifying call failures, human intervention is eliminated. As a result, human error in identification and in classification of call failures is reduced. Moreover, automating identification and classification of failed calls eliminates tedious and time consuming process of manually examining log files stored on a wireless device as well as on the wireless network. Furthermore, automating identification and classification of failed calls expedites the process for classifying call failures. Therefore, classification of call failures is performed in a timely fashion.

More specifically, one embodiment of the present invention pertains to a method of classifying a call failure in a wireless network including receiving the call failure indication; in response to the received call failure indication, automatically identifying the cause of the call failure; in response to the identification, automatically classifying the call failure; and outputting the call failure classification.

Embodiments include the above and wherein the call failure indication is received from a group comprising a wireless device, a mobile switching center and a base station controller. Moreover, embodiments include the above and wherein the identification includes determining signal characteristics, wherein the signal characteristics comprise signal strength and signal interference; determining the wireless network resource availability, wherein the resource availability comprises availability of communication channel; and determining cellular structure characteristics, wherein the cellular structure characteristics comprise configuration parameters defining the cellular structure and defining neighboring cellular structures.

Embodiments also include the above and wherein the call failure is classified as a coverage failure when the signal strength is below an acceptable threshold or when a wireless device initiates a call and receives no response from the wireless network or when the signal interference is above an acceptable threshold. Furthermore, embodiments include the above and wherein the call failure is classified as a capacity failure when the wireless network is unable to allocate a communication channel to a wireless device or when the wireless network is unable to allocate communication resources to a wireless device. In one embodiment, a failed call is classified as an operational failure when the configuration parameters fail to properly define the cellular structure or fail to properly identify neighboring cellular structures.

### BRIEF DESCRIPTION OF THE DRAWINGS

FIG. 1 shows an exemplary wireless device in a cellular communication system in accordance with one embodiment of the present invention.

FIG. 2 shows an exemplary handover of a wireless device in accordance with one embodiment of the present invention.

FIG. 3 shows a flow diagram of a computer implemented process for automating classifying a call failure in accordance with one embodiment of the present invention.

FIGS. 4A and 4B show a flow diagram of a computer implemented process for automatically identifying and in response thereto automatically classifying a call failure in accordance with one embodiment of the present invention.

FIG. 5 illustrates a general purpose computer system that may serve as a platform for receiving and gathering data in accordance with embodiments of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternative, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one ordinary skill in the art that the present invention may be practiced without these specific details. In other instances, well known methods, procedures, components, and circuits have not been described in detail as not to unnecessarily obscure aspects of the invention.

### Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from following discussions, it is appreciated that throughout the present invention, discussions utilizing terms such as “processing” or “creating” or “transferring” or “executing” or “determining” or “instructing” or “issuing” or “halting” or “clearing” or “accessing” or “aggregating” or “obtaining” or “selecting” or “initiating” or “receiving” or “analyzing” or “generating” or “constructing” or “outputting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### New Call Result Failure Classifications

In general, various technologies may be used to create a wireless network. For example, wireless network may be a wireless LAN, or Local Area Network. Radio frequencies may be used to establish a communication channel instead of wires to transmit data back and forth between the network and wireless devices. One technology currently used to create wireless network is Global System for Mobile (GSM) communications, which is divided into three major systems, the switching system, the base station system, and the operation and support system. A wireless device may be a personal digital assistant (PDA), a cellular telephone, a wireless laptop, a blackberry, a palm-pilot, a pager, or other portable wireless devices.

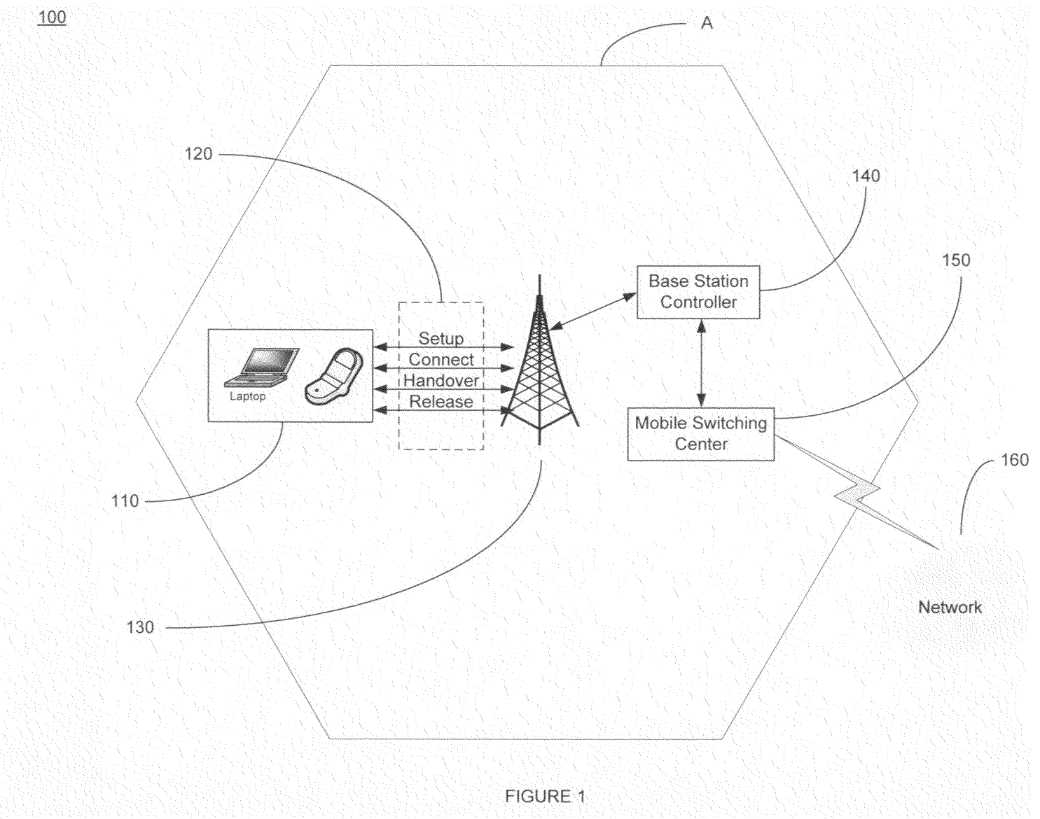

Referring now to FIG. 1, a wireless device (e.g., a cellular phone or a laptop) 110 may initiate a call to a base station 130 in order to establish a connection. In general, wireless networks are divided into a plurality of cellular structures (e.g., cellular structure A). Each cellular structure usually contains one base station. Each base station 130 may be controlled by a base station controller 140. The base station 130 may be coupled to a mobile switching center 150 where the wireless device may be transferred and connected to other networks through network 160. Other similar technologies such as Personal Communication System (PCS) may be similarly used. PCS is a radio band that can be used by mobile phones in North America. Similarly, technologies such as wireless fidelity (Wi-Fi) may be used to connect computers to the internet or other machines that are supported by Wi-Fi functionality. Wi-Fi networks broadcast radio waves that can be picked up by Wi-Fi receivers that are attached to different computers.

Referring still to FIG. 1, an exemplary wireless network system in accordance with one embodiment of the present invention is shown. A wireless device 110 communicates with the base station 130. In general, the wireless device 110 is in constant communication with the base station 130. In one embodiment, the messages exchanged between the wireless device 110 and the base station 130 may be a layer three messaging 120 in compliance with the open system interconnection (OSI) model. In one embodiment, radio frequency (RF) status messaging may be used. It is appreciated that even though this application is discussed with respect to layer three messaging and RF status messaging, other types of messaging may be similarly used. As such, describing the embodiments of the present invention in terms of layer three messaging and RF status messaging is exemplary and it is not intended to limit the scope of the present invention.

Layer three messaging 120 may comprise a setup message, a connect message, a handover message and a release message among others. For example, a setup message may initiate a call setup. Accordingly, parameters required to establish a connection between the wireless device 110 and the base station 130 may be communicated to the wireless device 110. For instance, a call setup may comprise a request for a communication channel (e.g., radio frequency) to establish a communication connection. Similarly, a connect message may initiate a call connection whereby a communication channel between the wireless device 110 and the base station 130 is established. The layer three messaging 120 may also comprise a handover message when a call is established and when a wireless device 110 is traveling from its cellular structure A to one of its neighboring cellular structures. Layer three messaging 120 may also comprise a release message whereby a connection established earlier is terminated and resources used by the wireless device 110 is released back to the wireless network.

RF status messaging may comprise data information similar to that of layer three messaging. For example, RF status messaging may comprise a call setup, resource allocation and handover call indication. Moreover, RF status may be used to determine network efficiency and/or efficiency in assigning pseudo noise (PN) code and/or the condition of the network in general. Furthermore, RF status may comprise a cause code which provides additional information. For example, cause code number 38 may indicate that the network is out of order, cause code number 42 may indicate switching equipment congestion and cause code number 44 may indicate that a communication channel is not available. It is appreciated that cause code provides additional information and functionality. Therefore, the cause codes described above are exemplary and are not intended to limit the scope of the invention.

Accordingly, layer three messages 120 and/or RF messages stored in a wireless device 110 or in the wireless network (e.g., base station controller 140) may be used to obtain valuable information. For example, the signal strength and the signal interference may be determined. Moreover, the signal quality may be obtained. For example, the signal quality may be stored as a hexadecimal number in the layer three messaging or RF status. Accordingly, the information stored in the layer three messaging 120 and/or RF status messages may be used to determine whether a failed called was due to unavailability of communication channel, unavailability of resources, handover problems, low signal strength or high signal interference, to name a few. It is appreciated that the cause of call failure described above is exemplary and not intended to limit the scope of the present invention.

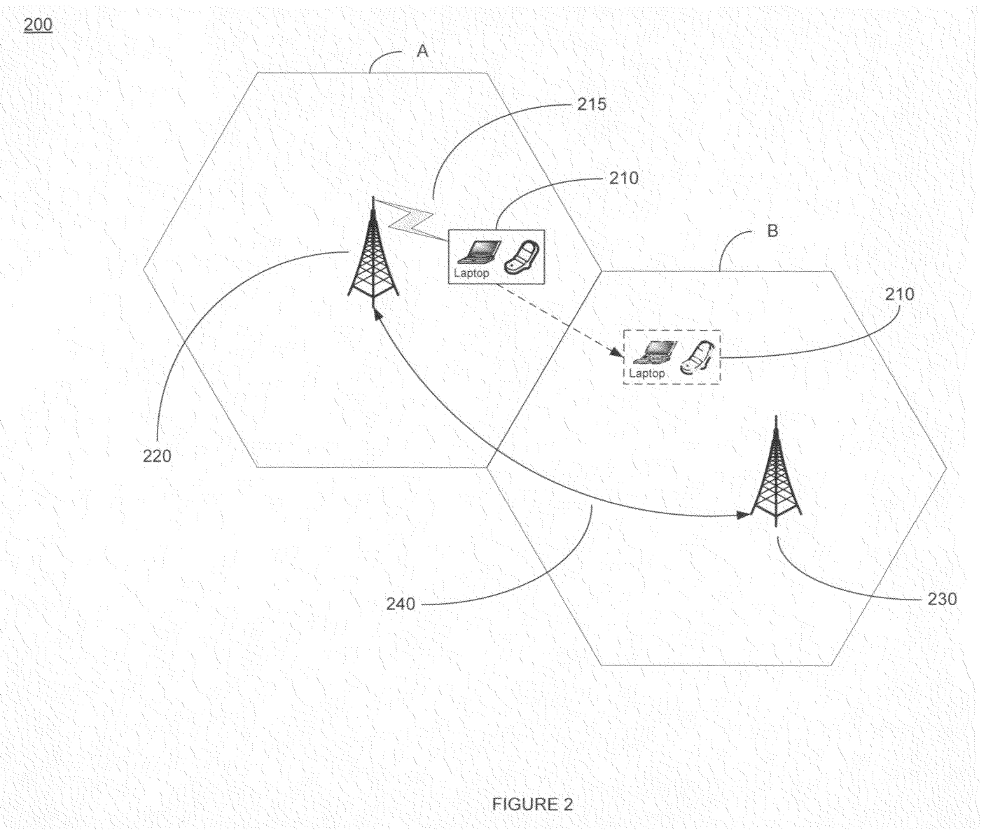

Referring now to FIG. 2, an exemplary system 200 for handling handover of a wireless device in accordance with one embodiment of the present invention is shown. Wireless system 200 comprises two adjacent cellular structures, A and B. It is appreciated that a cellular structure may have more than one neighboring cellular structure. However, for simplicity only one neighboring cellular structure is shown.

In this embodiment, a wireless device 210 is connected to a base station 220 in cellular structure A and communicates over a communication channel 215. It is appreciated that each cellular structure may further comprise a base station controller, a mobile switching center, a network and additional structures as described above (not shown). In this embodiment, the wireless device 210 is traveling from cellular structure A to its neighboring cellular structure B. Accordingly, as the wireless device 210 travels from cellular structure A to cellular structure B, its signal strength becomes weaker with respect to cellular structure A. Accordingly, if the communication channel 215 is not handed over to another cellular structure (e.g., cellular structure B) with a higher signal strength, the call will be dropped. Accordingly, when the wireless device 210 is traveling from its cellular structure to another cellular structure, the communication channel should be handed over to keep the established connection alive.

Accordingly, the base station 220 communicates with base station 230 in cellular structure B. Communication between the base station 220 and the base station 230 is represented by signal 240. The two base stations communicate over communication line 240 to determine whether cellular structure B has the capacity to accommodate an additional wireless device 210. When cellular structure B has the capacity (e.g., communication channel, the signal strength and etc.) to accommodate an additional wireless user, the call is handed over to cellular structure B.

On the other hand, when resources of cellular structure B are fully utilized, cellular structure B communicates that it is incapable of handling additional wireless user. These messages may be stored by the wireless device and/or the wireless device network. The messages between the two base stations may be in RF status format having a cause code. For example, cellular structure B may send a cause code number 42 to cellular structure A indicating switching equipment congestion. Similarly, cellular structure B may send a cause code number 44 to cellular structure A indicating that a channel is not available to accommodate an additional wireless user. Under these circumstances, a handover of a call fails.

In general, each base station has a configuration file comprising parameters that define the cellular structure. Moreover, the configuration file may comprise parameters that may define and identify neighboring cellular structures with their characteristics. For example, cellular structure A may have a configuration file comprising parameter that define and identify cellular structure B. For example, parameters may define the signal strength to be used by the wireless device in order to have minimal impact on signal interference. Parameters may also define the type or the algorithm generating PN codes.

Configuration files are generally generated by network engineers. Accordingly, configuration files are prone to human error. For example, the configuration file used for cellular structure A may inadvertently leave out the parameters that define and identify cellular structure B. Under these circumstances, handing over of a call fails when the wireless device user 210 is traveling from cellular structure A to cellular structure B. Handover fails because the configuration file for cellular structure A does not have the parameters to identify and define cellular structure B. Accordingly, the wireless device 210 is oblivious of the fact that it is entering cellular structure B and the call is not handed over. As a result, the call drops. Inadvertent mistakes associated with the configuration file entered by network engineers are referred to as operational problem.

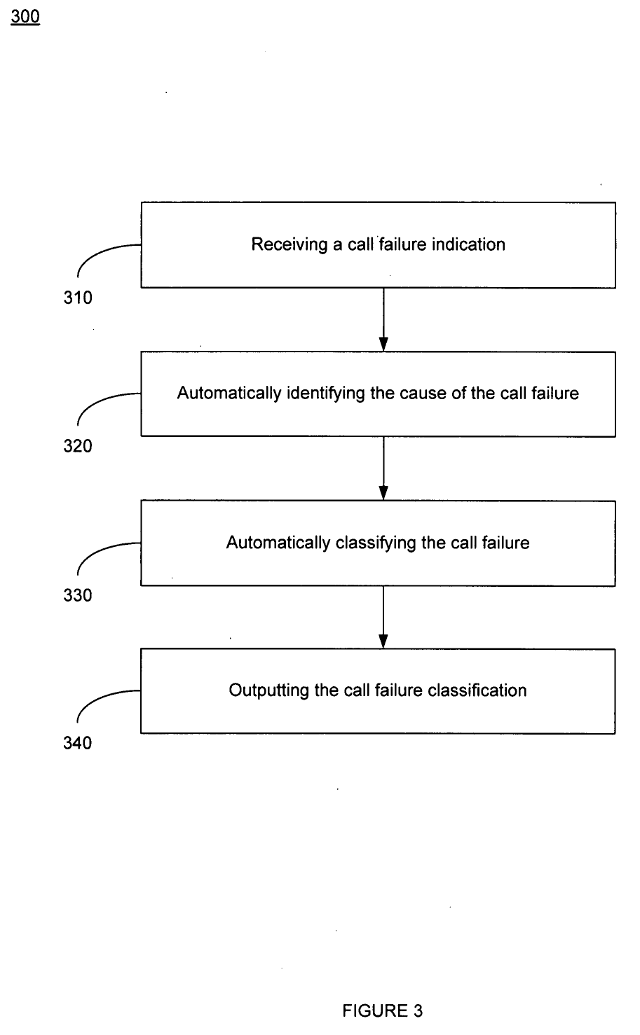

Referring now to FIG. 3, a flow diagram 300 of a computer implemented process for automatically classifying a call failure in accordance with one embodiment of the present invention is shown. At step 310, a call failure indication is received. It is appreciated that a call failure indication may be stored on a wireless device and/or on a wireless network. It is further appreciated that a call failure indication may be detected from a layer three messaging, RF status messaging, cause codes or similar messaging methods as described above. At step 320, the cause of the call failure is automatically identified. For example, a call failure may be due to low signal strength. A call failure may be due to high signal interference, lack of communication channel during handover or during call initiation, lack of resources during handover or during call initiation, or due to inadvertent mistake in defining and identifying neighboring cellular structures, to name a few. It is appreciated that the cause of call failures are not limited to the circumstances described above and that the cause of call failures described herein are exemplary and not intended to limit the scope of the present invention.

At step 330, call failures are automatically classified. For example, a call failure may be classified as a coverage failure when the signal strength is below an acceptable threshold (e.g., −113 dB). Similarly a call failure may be classified as a coverage failure when the signal interference is above a given threshold. In one embodiment, a call failure may be classified as a capacity failure when the cellular structure does not have a communication channel or the network capacity to accommodate an additional wireless device. It is appreciated, that a call failure may be classified as a coverage failure regardless of whether the call failure occurred during handover or when a wireless device initially sought to establish a connection. In one embodiment, a call failure is classified as operational failure for calls that fail because of inadvertent mistakes by network engineers in defining and identifying cellular structures as well as their neighboring cellular structures.

Referring still to FIG. 3, at step 340 the automatic classification of failed calls may be outputted. For example, the classification may be displayed on a screen, printed out, output as an audio or stored for later retrieval. It is appreciated that the output may be provided as a percentage. For example, the output may indicate that 10% of the call failures were due to capacity failure, 35% of the call failures were due to operational failure and 55% of the call failures were due to coverage failure. In one embodiment, call failures are automatically classified into coverage, capacity, or operational.

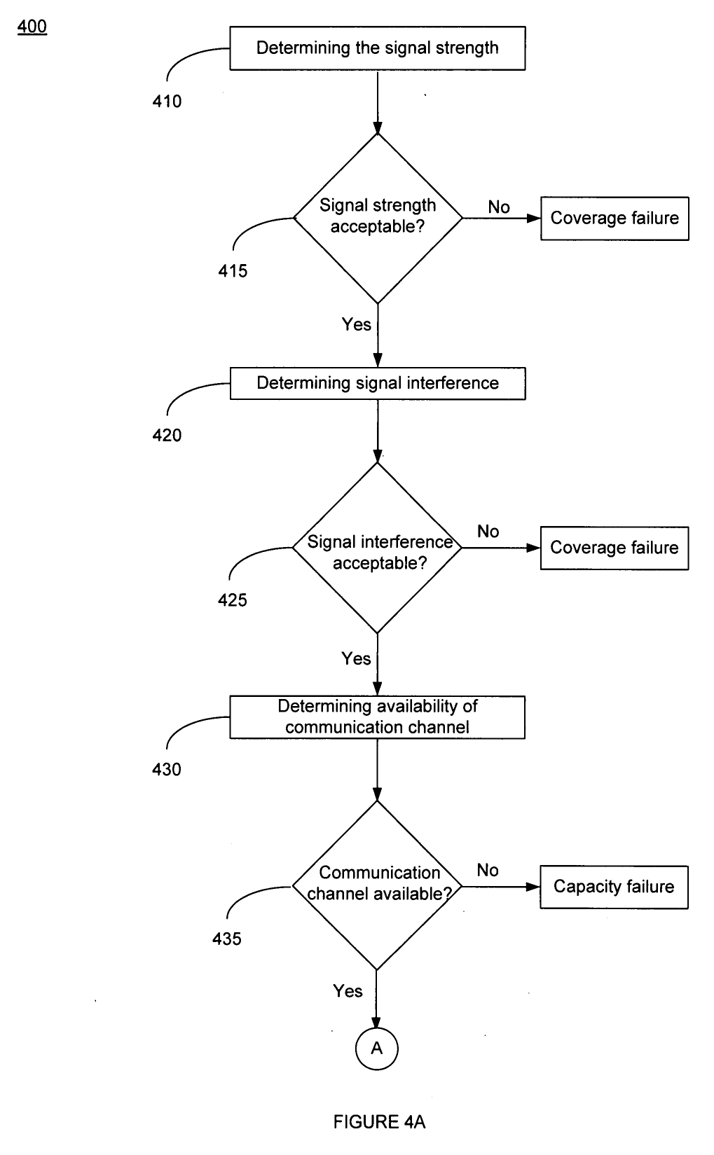

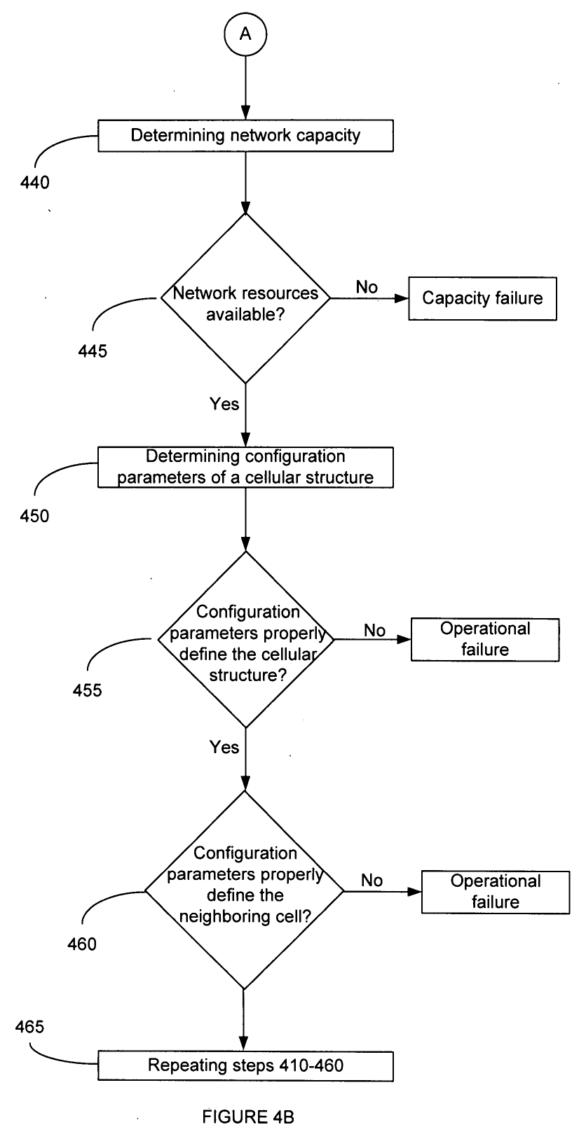

Referring now to FIGS. 4A and 4B, a flow diagram 400 of a computer implemented process for automatically identifying and in response thereto automatically classifying a call failure in accordance with one embodiment of the present invention is shown. Using layer three messaging, RF status messaging and cause codes described above, at step 410 the signal strength for a wireless device is determined. At step 415, the signal strength is compared to an acceptable threshold (e.g., −113 dB). If the signal strength is below an acceptable threshold, the call failure is classified as a coverage failure.

At step 420 the signal interference is determined. At step 425, signal interference is compared to an acceptable signal interference threshold. If the signal interference is above the acceptable threshold, the call failure may be automatically classified as a coverage failure. In one embodiment, a call failure may be automatically classified as a coverage failure when a wireless device initiates a call to a wireless network in order to connect but receives no response from the wireless network. In one embodiment, the request may be sent a multiple times and if no response is received in a given time, the call failure may be automatically classified as a coverage failure.

Referring still to FIGS. 4A and 4B, at step 430 availability of communication channel (e.g., RF channel) is determined. In one embodiment, cause code 44 may be used to determine availability of communication channel. According to one embodiment, at step 435, if a communication channel is not available the call failure is automatically classified as a capacity failure. For example, when a wireless device initiates a call to the base station but the base station is unable to assign a communication channel to the wireless device, the call failure may be automatically classified as a capacity failure. It is appreciated that the determination of communication channel availability may be based on layer three messaging and RF status or other similar methods or any combination thereof.

Similarly, when a wireless device is traveling from a first cellular structure to a second cellular structure but the second cellular structure is unable to assign a communication channel to the wireless device, the call failure may be automatically classified as a capacity failure. In one embodiment, additional classifications may be created. For example, a call failure due to unavailability of a communication channel during handover may be classified as handover capacity failure.

At step 440, the network capacity is determined. For example, cause code number 42 may be used to determine network capacity. At step 445, if congestion at the switching equipment is determined, the call failure is automatically classified as a capacity failure.

At step 450, configuration parameters of a cellular structure are determined. For example, parameters defining a cellular structure that a wireless device resides in may be determined. At step 455, if the configuration parameters fail to properly define the cellular structure, the call failure is automatically classified as an operational failure. At step 460, if parameters fail to properly define and identify neighboring cellular structures, the call failure is automatically classified as an operational failure.

It is appreciated that in one embodiment, if the call failure is not classified as a coverage or capacity failure, it may be classified as an operational failure by default. It is also appreciated that classifying a call failure as an operational failure may be based on statistical analysis of the configuration file of a cellular structure. Therefore, configuration file of a cellular structure where call failure occurs may be statistically compared to the configuration file of a cellular structure where the call was successful. Accordingly, if the statistical difference is above a certain threshold a call failure may be automatically classified as an operational failure.

It is appreciated that at step 465, steps 410-460 may be repeated for other call failures. Accordingly, repeating the process for a large enough sample, provides a statistically accurate indication and classification of a failed call. It is further appreciated that the method 300 and 400 may be repeated for multiple cellular structures to obtain a statistically accurate information for a given wireless network (e.g., Verizon, Cingular, T-Mobile, and etc.).

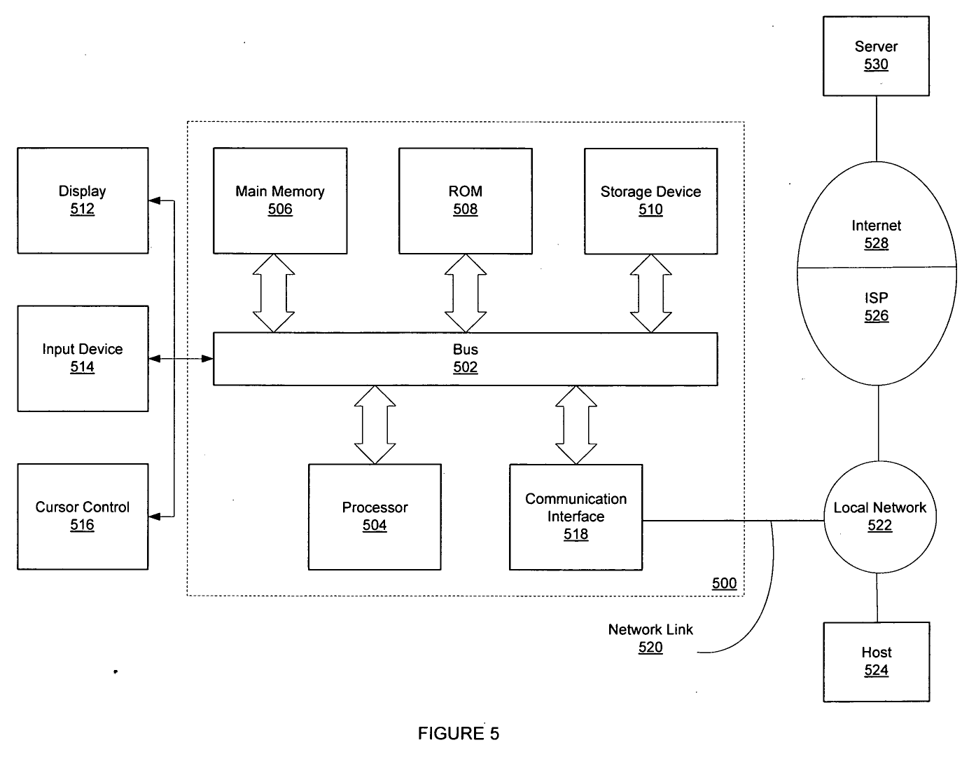

FIG. 5 is a block diagram that illustrates a computer system 500 upon which an embodiment of the invention may be implemented. Computer system 500 may implement the methods 300 and 400 as shown in FIGS. 3, 4A and 4B and includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A non-volatile storage device 510, such as a magnetic disk or optical disk, is provided and coupled to bus 502 for storing information and instructions and may store the persistent internal queue.

Computer system 500 may be coupled via bus 502 to an optional display 512, such as a cathode ray tube (CRT), for displaying information to a computer user. An optional input device 514, including alphanumeric and other keys, may be coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512.

The invention is related to the use of computer system 500 for classifying a call failure in a wireless network. According to one embodiment of the invention, the interface is used in response to processor 504 executing one or more sequences of one or more instructions contained in main memory 506 e.g., to implement process 100. Such instructions may be read into main memory 506 from another computer readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of carrier waves transporting the information.

Computer system 500 can send and receive messages through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of classifying a call failure in a wireless network, said method comprising:
receiving said call failure indication;
in response to said received call failure indication, automatically identifying the cause of said call failure;
in response to said identification, automatically classifying said call failure; and
outputting said call failure classification.

2. The method as described in claim 1, wherein said call failure indication is received from a group comprising a wireless device, a mobile switching center and a base station controller.

3. The method as described in claim 1, wherein said identification comprises:
determining signal characteristics, wherein said signal characteristics comprise signal strength and signal interference;
determining said wireless network resource availability, wherein said resource availability comprises availability of communication channel; and
determining cellular structure characteristics, wherein said cellular structure characteristics comprise configuration parameters defining said cellular structure and defining neighboring cellular structures.

4. The method as described in claim 3, wherein said call failure is classified as a coverage failure when said signal strength is below an acceptable threshold.

5. The method as described in claim 3, wherein said call failure is classified as a coverage failure when a wireless device initiates a call and receives no response from said wireless network.

6. The method as described in claim 3, wherein said call failure is classified as a coverage failure when said signal interference is above an acceptable threshold.

7. The method as described in claim 3, wherein said call failure is classified as a capacity failure when said wireless network is unable to allocate a communication channel to a wireless device.

8. The method as described in claim 3, wherein said call failure is classified as a capacity failure when said wireless network is unable to allocate communication resources to a wireless device.

9. The method as described in claim 3, wherein said call failure is classified as an operational failure when said configuration parameters fail to properly define said cellular structure or fail to properly identify neighboring cellular structures.

10. A computer-useable medium having computer-readable program code stored thereon for causing a computer system to execute a method for classifying a call failure, said method comprising:
receiving said call failure indication;
in response to said received call failure indication, automatically identifying the cause of said call failure;
in response to said identification, automatically classifying said call failure; and
outputting said call failure classification.

11. The computer-useable medium as described in claim 10, wherein said call failure indication is received from a group comprising a wireless device, a mobile switching center and a base station controller.

12. The computer-useable medium as described in claim 10, wherein said identification comprises:
determining signal characteristics, wherein said signal characteristics comprise signal strength and signal interference;
determining said wireless network resource availability, wherein said resource availability comprises availability of communication channel; and
determining cellular structure characteristics, wherein said cellular structure characteristics comprise configuration parameters defining said cellular structure and defining neighboring cellular structures.

13. The computer-useable medium as described in claim 12, wherein said call failure is classified as a coverage failure when said signal strength is below an acceptable threshold.

14. The computer-useable medium as described in claim 12, wherein said call failure is classified as a coverage failure when a wireless device initiates a call and receives no response from said wireless network.

15. The computer-useable medium as described in claim 12, wherein said call failure is classified as a coverage failure when said signal interference is above an acceptable threshold.

16. The computer-useable medium as described in claim 12, wherein said call failure is classified as a capacity failure when said wireless network is unable to allocate a communication channel to a wireless device.

17. The computer-useable medium as described in claim 12, wherein said call failure is classified as a capacity failure when said wireless network is unable to allocate communication resources to a wireless device.

18. The computer-useable medium as described in claim 12, wherein said call failure is classified as an operational failure when said configuration parameters fail to properly define said cellular structure or fail to properly identify neighboring cellular structures.

19. A computer system comprising a processor coupled to a bus, a transmitter/receiver coupled to said bus, and a memory coupled to said bus, wherein said memory comprises instructions that when executed on said processor implement a method for classifying a call failure, said method comprising:
receiving said call failure indication;
in response to said received call failure indication, automatically identifying the cause of said call failure;
in response to said identification, automatically classifying said call failure; and
outputting said call failure classification.

20. The computer system as described in claim 19, wherein said call failure indication is received from a group comprising a wireless device, a mobile switching center and a base station controller.

21. The computer system as described in claim 19, wherein said identification comprises:
determining signal characteristics, wherein said signal characteristics comprise signal strength and signal interference;
determining said wireless network resource availability, wherein said resource availability comprises availability of communication channel; and
determining cellular structure characteristics, wherein said cellular structure characteristics comprise configuration parameters defining said cellular structure and defining neighboring cellular structures.

22. The computer system as described in claim 21, wherein said call failure is classified as a coverage failure when said signal strength is below an acceptable threshold.

23. The computer system as described in claim 21, wherein said call failure is classified as a coverage failure when a wireless device initiates a call and receives no response from said wireless network.

24. The computer system as described in claim 21, wherein said call failure is classified as a coverage failure when said signal interference is above an acceptable threshold.

25. The computer system as described in claim 21, wherein said call failure is classified as a capacity failure when said wireless network is unable to allocate a communication channel to a wireless device.

26. The computer system as described in claim 21, wherein said call failure is classified as a capacity failure when said wireless network is unable to allocate communication resources to a wireless device.

27. The computer system as described in claim 21, wherein said call failure is classified as an operational failure when said configuration parameters fail to properly define said cellular structure or fail to properly identify neighboring cellular structures.
